(19) United States
(12) Patent Application Publication
(10) Pub. No.: US 2026/0111028 A1
(43) Pub. Date: Apr. 23, 2026

(54) GLOBAL LOCALIZATION APPARATUS AND METHOD THEREOF

(71) Applicants: Hyundai Motor Company, Seoul (KR); Kia Corporation, Seoul (KR)

(72) Inventor: Chan Gyo Lee, Hwaseong-si (KR)

(21) Appl. No.: 19/098,058

(22) Filed: Apr. 2, 2025

(30) Foreign Application Priority Data
Oct. 17, 2024 (KR) 10-2024-0142400

(51) Int. Cl. G05D 1/246; G01S 17/89; G05D 111/10; G05D 111/30; G06V 10/22; G06V 10/42

(52) U.S. Cl. CPC G05D 1/246; G01S 17/89; G06V 10/23; G06V 10/42; G05D 2111/17; G05D 2111/30

(57) ABSTRACT

In an embodiment a global localization apparatus includes a memory storing computer-executable instructions and at least one processor, wherein the instructions, when executed by the at least one processor, enable the apparatus to obtain robot pose data of a position and a direction of a robot, to obtain a target image corresponding to a target space where the robot is located from an image acquisition device of the robot, to generate an image map of the target space based on the robot pose data and the target image, and to obtain a global position of the robot based on the image map and a light detection and ranging (LiDAR) map obtained from a LiDAR of the robot.

### CROSS-REFERENCE TO RELATED APPLICATIONS

This application claims the benefit of priority to Korean Patent Application No. 10-2024-0142400, filed in the Korean Intellectual Property Office on Oct. 17, 2024, the entire contents of which are incorporated herein by reference.

### TECHNICAL FIELD

The present disclosure relates to a global localization apparatus and a method for localizing a global localization apparatus such as estimating a position of a robot.

### SUMMARY

Embodiments provide a global localization apparatus and a method for localizing a global localization apparatus such as estimating a position of a robot.

The global localization apparatus may integrate data of a camera and data of light detection and ranging (LiDAR) and may enable a high-definition localization of a robot with reduced computational time and cost and with reduced sensitivity for environment changes in order to reduce errors. The global localization apparatus may be located in a robot or outside of a robot, e.g., spaced apart from the robot.

Various embodiments provide an estimation for an accurate global position of a robot.

Embodiments provides a global localization apparatus for generating an image map about a target space based on robot pose data and a target image, and obtaining a global position of a robot based on the image map and a LiDAR map obtained from LiDAR to combine information of camera and LiDAR data and accurately estimate and/or determine a position of the robot located in a confusing or complex indoor environment or an environment with an unstable GPS signal.

Further embodiments provide a method thereof.

According to embodiments, a global localization apparatus may include a memory storing computer-executable instructions and at least one processor that accesses the memory and executes the instructions. The at least one processor may obtain robot pose data of a position and a direction of a robot and may obtain a target image corresponding to a target space where the robot is located from an image acquisition device included in the robot, may generate an image map of the target space based on the robot pose data and the target image, and may obtain a global position of the robot based on the image map and a light detection and ranging (LiDAR) map obtained from LiDAR.

In an embodiment, the at least one processor may identify a first time point preceding a target time point when the target image is obtained and a second time point subsequent to the target time point when the target image is obtained, may obtain a time weight of the target time point based on first robot pose data of the robot, the first robot pose data corresponding to the first time point, and second robot pose data of the robot, the second robot pose data corresponding to the second time point, and may obtain the robot pose data corresponding to the target time point based on the first robot pose data, the second robot pose data, and the time weight.

In an embodiment, the at least one processor may apply an external parameter including a position and a direction of the image acquisition device in the target space to the robot pose data to obtain image pose data of a position and a direction of the target image and may store the image pose data and the target image in the memory.

In an embodiment, the at least one processor may combine at least one of the image pose data, the robot pose data, the external parameter, or any combination thereof with the target image stored in the memory to generate a target keyframe, may apply the target keyframe to a first feature extraction model for extracting a feature of a point of an object to obtain first data of a point feature of the object, the point feature being included in the target keyframe, may apply the target keyframe to a second feature extraction model for extracting a feature of a line of the object to obtain second data of a line feature of the object, the line feature being included in the target keyframe, may apply the target keyframe to a third feature extraction model for extracting a global feature of an object arrangement or color distribution to obtain third data of a global feature of the target keyframe, and may store the target keyframe, the first data, the second data, and the third data in a keyframe database.

In an embodiment, the at least one processor may obtain at least one sub-keyframe from the keyframe database, may determine a cosine similarity between the global feature of the target keyframe and a global feature of each of the at least one sub-keyframe, may determine sub-keyframes in which the cosine similarity of each of the at least one sub-keyframe corresponds to a predetermine score to generate a target group including the determined sub-keyframes and the target keyframe, and may perform two-dimensional (2D) feature point matching between the keyframes included in the target group based on a fast library for approximate nearest neighbors (FLANN) algorithm.

In an embodiment, the at least one processor may identify a first keyframe and a second keyframe among the keyframes included in the target group and may match a 2D feature point included in the first keyframe with a 2D feature point included in the second keyframe based on that the 2D feature point included in the first keyframe and the 2D feature point included in the second keyframe correspond to the same target in the target space.

In an embodiment, the at least one processor may transform a robot coordinate system of each of the keyframes included in the target group into a coordinate system of the image acquisition device, may perform three-dimensional (3D) triangulation based on the result of the 2D feature point matching between the keyframes included in the target group, an internal parameter of a lens characteristic of the image acquisition device, and the image pose data of the target image, may obtain a point cloud based on a 3D feature point obtained by projecting a 2D feature point of each of the keyframes included in the target group onto a 3D space, through the 3D triangulation, and may generate a first image map, being a 3D sparse image map, based on the point cloud.

In an embodiment, the at least one processor may optimize the first image map, though global bundle adjustment of the 3D feature point, the 2D feature point of each of the keyframes included in the target group, the internal parameter, and the robot pose data.

In an embodiment, the at least one processor may perform 3D Gaussian splatting for the 3D feature point, the external parameter, the internal parameter, and the target image to obtain a projected image, may update the projected image, based on a loss between the projected image and the target image, may obtain a second image map being a 3D dense image map, based on that the projected image is updated, and may transmit the second image map to a control server.

In an embodiment, the at least one processor may obtain a query image from the image acquisition device, based on receiving an event about a global localization of the robot, may determine a cosine similarity between a query frame about the query image and each of at least one sub-keyframe included in the keyframe database to generate a query group including sub-keyframes similar to the query frame, may perform 3D triangulation of the keyframes included in the query group to obtain a 3D feature point, and may match a 2D feature point of the query frame with the 3D feature point to obtain at least one candidate position of an estimated position of the robot.

In an embodiment, the at least one processor may determine scores of each of the at least one candidate position based on the at least one candidate position and the LiDAR map obtained from the LiDAR, and may identify a target candidate position about a score corresponding to a predetermined score among the scores of each of the at least one candidate position, and may determine the target candidate position as the global position.

According to further embodiments a global localization method may include obtaining robot pose data of a position and a direction of a robot and obtaining a target image corresponding to a target space where the robot is located from an image acquisition device included in the robot, generating an image map of the target space based on the robot pose data and the target image, and obtaining a global position of the robot based on the image map and a light detection and ranging (LiDAR) map obtained from LiDAR.

In an embodiment, the obtaining of the target image may include identifying a first time point preceding a target time point when the target image is obtained and a second time point subsequent to the target time point when the target image is obtained, obtaining a time weight of the target time point, based on first robot pose data of the robot, the first robot pose data corresponding to the first time point, and second robot pose data of the robot, the second robot pose data corresponding to the second time point, and obtaining the robot pose data corresponding to the target time point, based on the first robot pose data, the second robot pose data, and the time weight.

In an embodiment, the obtaining of the robot pose data may include applying an external parameter including a position and a direction of the image acquisition device in the target space to the robot pose data to obtain image pose data of a position and a direction of the target image and storing the image pose data and the target image in a memory.

In an embodiment, the storing of the image pose data and the target image in the memory may include combining at least one of the image pose data, the robot pose data, the external parameter, or any combination thereof with the target image stored in the memory to generate a target keyframe, applying the target keyframe to a first feature extraction model for extracting a feature of a point of an object to obtain first data of a point feature of the object, the point feature being included in the target keyframe, applying the target keyframe to a second feature extraction model for extracting a feature of a line of the object to obtain second data of a line feature of the object, the line feature being included in the target keyframe, applying the target keyframe to a third feature extraction model for extracting a global feature of an object arrangement or color distribution to obtain third data of a global feature of the target keyframe, and storing the target keyframe, the first data, the second data, and the third data in a keyframe database.

In an embodiment, the storing of the image pose data and the target image in the memory may include obtaining at least one sub-keyframe from the keyframe database, determining a cosine similarity between the global feature of the target keyframe and a global feature of each of the at least one sub-keyframe, determining sub-keyframes in which the cosine similarity of each of the at least one sub-keyframe corresponds to a predetermine score to generate a target group including the determined sub-keyframes and the target keyframe, and performing 2D feature point matching between the keyframes included in the target group, based on a fast library for approximate nearest neighbors (FLANN) algorithm.

In an embodiment, the performing of the 2D feature point matching between the keyframes included in the target group may include identifying a first keyframe and a second keyframe among the keyframes included in the target group and matching a 2D feature point included in the first keyframe with a 2D feature point included in the second keyframe based on that the 2D feature point included in the first keyframe and the 2D feature point included in the second keyframe correspond to the same target in the target space.

In an embodiment, the generating of the image map may include transforming a robot coordinate system of each of the keyframes included in the target group into a coordinate system of the image acquisition device, performing 3D triangulation based on the result of the 2D feature point matching between the keyframes included in the target group, an internal parameter of a lens characteristic of the image acquisition device, and the image pose data of the target image, obtaining a point cloud based on a 3D feature point obtained by projecting a 2D feature point of each of the keyframes included in the target group onto a 3D space, through the 3D triangulation, and generating a first image map being a 3D sparse image map, based on the point cloud.

In an embodiment, the generating of the image map may include performing 3D Gaussian splatting for the 3D feature point, the external parameter, the internal parameter, and the target image to obtain a projected image, updating the projected image, based on a loss between the projected image and the target image, obtaining a second image map being a 3D dense image map based on that the projected image is updated, and transmitting the second image map to a control server.

In an embodiment, the obtaining of the global position of the robot may include obtaining a query image from the image acquisition device based on receiving an event about global localization of the robot, determining a cosine similarity between a query frame of the query image and each of at least one sub-keyframe included in the keyframe database to generate a query group including sub-keyframes similar to the query frame, performing 3D triangulation of the keyframes included in the query group to obtain a 3D feature point, matching a 2D feature point of the query frame with the 3D feature point to obtain at least one candidate position of an estimated position of the robot, determining scores of each of the at least one candidate position, based on the at least one candidate position and the LiDAR map obtained from the LiDAR, identifying a target candidate position about a score corresponding to a predetermined score among the scores of each of the at least one candidate position, and determining the target candidate position as the global position.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a block diagram of a global localization apparatus according to an embodiment of the present disclosure;

FIG. 2 is a flowchart describing a global localization method according to an embodiment of the present disclosure;

FIG. 3 is a drawing describing a method for performing data acquisition, image map generation, and global localization in a global localization apparatus according to an embodiment of the present disclosure;

FIG. 4 is a drawing describing a method for constructing a keyframe database in a global localization apparatus according to an embodiment of the present disclosure;

FIG. 5A is a drawing describing a method for measuring a similarity between keyframes in a global localization apparatus according to an embodiment of the present disclosure;

FIG. 5B illustrates a pseudocode indicating a source code for generating a target group;

FIG. 6 is a drawing describing a method for generating a first image map in a global localization apparatus according to an embodiment of the present disclosure;

FIG. 7 is a drawing describing 3D triangulation, in a global localization apparatus according to an embodiment of the present disclosure;

FIG. 8 is a drawing describing a method for generating a second image map in a global localization apparatus according to an embodiment of the present disclosure;

FIG. 9 is a drawing illustrating a method for estimating a global position of a robot in a global localization apparatus according to an embodiment of the present disclosure; and

FIG. 10 is a drawing illustrating a computing system associated with a global localization apparatus or a global localization method according to an embodiment of the present disclosure.

With regard to description of drawings, the same or similar components will be marked by the same or similar reference signs.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure. Particularly, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. It will be understood that terms used herein should be interpreted as having a meaning that is consistent with their meaning in the context of this present disclosure and the relevant art and will not be interpreted in an idealized or overly formal sense unless expressly so defined herein. For example, the terms, such as “first”, “second”, “1st”, “2nd”, or the like used in the present disclosure may be used to refer to various components regardless of the order and/or the priority and to distinguish one component from another component, but do not limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It will be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to the situation, the expression “configured to” used in the present disclosure may be used exchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in the present disclosure are used to describe specified embodiments and are not intended to limit the scope of another embodiment. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms which are defined in the specification, they may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one Bare included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

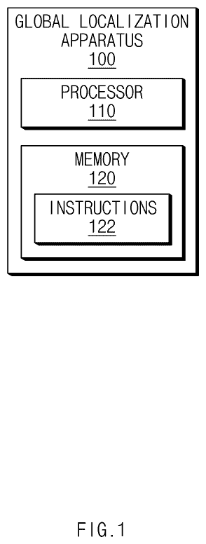

Embodiments of the present disclosure will be described in detail with reference to FIGS. 1 to 10.

FIG. 1 is a drawing illustrating a block diagram of a global localization apparatus according to an embodiment of the present disclosure.

A global localization apparatus 100 according to an embodiment may include a processor 110 and a memory 120 including instructions 122.

The global localization apparatus 100 may be an apparatus for estimating and/or determining a position of a robot. For example, the global localization apparatus 100 may generate three-dimensional (3D) image maps based on position information of the robot and camera data to estimate and/or determine the position of the robot based on the generated image maps and a light detection and ranging (LiDAR) map.

The processor 110 may execute software and may control at least one other component (e.g., a hardware or software component) connected with the processor 110. In addition, the processor 110 may perform a variety of data processing or computation. For example, the processor 110 may store the position information of the robot, the camera data, the image map, or the LiDAR map in the memory 120.

For reference, the processor 110 may perform all operations performed by the global localization apparatus 100. Therefore, the operation performed by the global localization apparatus 100 is mainly described as an operation performed by the processor 110. Furthermore, the processor 110 is mainly described as, but not limited to, a single processor. For example, the global localization apparatus 100 may include at least one processor. Each of the at least one processor may perform all operations associated with an operation of estimating and/or determining a position of the robot.

The memory 120 may store temporarily and/or permanently store various pieces of data and/or information required to perform the operation of estimating/or determining the position of the robot. For example, the memory 120 may store the position information of the robot, the camera data, the image map, or the LiDAR map.

The global localization apparatus 100 may further include a communication device. The communication device may assist in performing communication between the global localization apparatus 100 and a control server. For example, the communication device may include one or more components for performing communication between the global localization apparatus 100 and the control server. In detail, the communication device may include a short-range wireless communication unit, a microphone, or the like. At this time, a short-range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

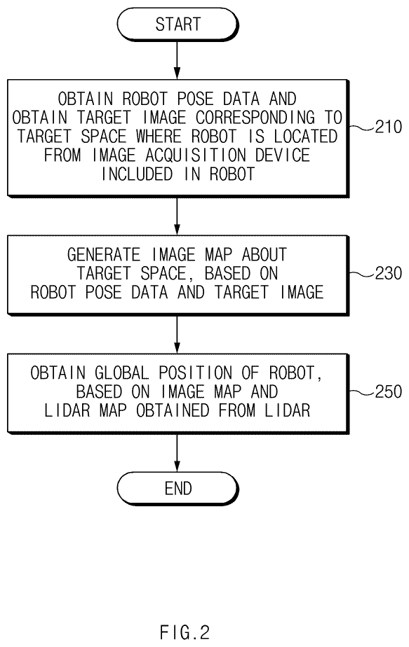

FIG. 2 is a flowchart describing a global localization method according to an embodiment of the present disclosure.

In operation 210, a processor (e.g., a processor 110 of FIG. 1) according to an embodiment may obtain robot pose data and may obtain a target image corresponding to a target space where a robot is located from an image acquisition device included in the robot.

The robot pose data may include information about a position (e.g., x, y, and z coordinates) of the robot and a direction (e.g., roll, pitch, and yaw) of the robot. In detail, the robot pose data may include the position of the robot and the direction of the robot in a 3D space. The position of the robot may indicate whether the robot is in any position in the target space. The direction of the robot may indicate whether the robot faces any direction in the target space.

The image acquisition device included in the robot may include a camera. For example, the camera may be included and/or mounted in the robot to obtain an image including an environment around the robot which is moving or stopped.

The target space may indicate a real space which is a 3D space where the robot is located. A robot coordinate system may indicate a coordinate system, including predetermined axes, for representing a position and a direction of the robot located in the target space.

In operation 230, the processor may generate an image map about the target space, based on the robot pose data and the target image. For example, the image map may indicate a map on which the target space where the robot is located is digitally represented. In detail, the image map may include a 3D sparse image map on which some important feature points selectively appear in the space where the robot is located and a 3D dense image map on which all surfaces, structures, objects, or the like of the space where the robot is located appear in high resolution.

In operation 250, the processor may obtain a global position of the robot, based on the image map and a LiDAR map obtained from LiDAR. In detail, the global position of the robot may indicate a position of the robot in the target space, after a target time point when the target image is obtained. In detail, the global position of the robot may refer to a position of the robot on a coordinate system (i.e., an earth coordinate system) of the target space. For example, the processor may perform operation 210 and operation 230 to generate the image map. After generating the image map, the processor may obtain a position of the robot at a time point when a query image is obtained, based on an image (e.g., the query image) different from the target image and the LiDAR map.

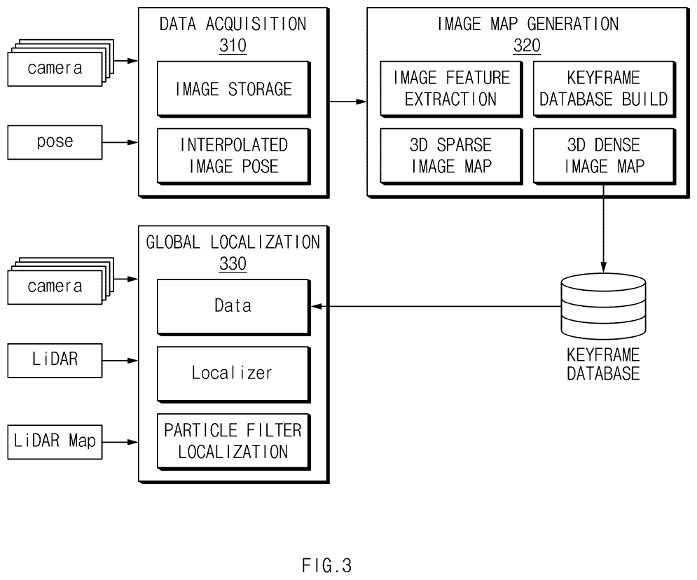

FIG. 3 describes a method for performing data acquisition, image map generation, and global localization in a global localization apparatus according to an embodiment of the present disclosure.

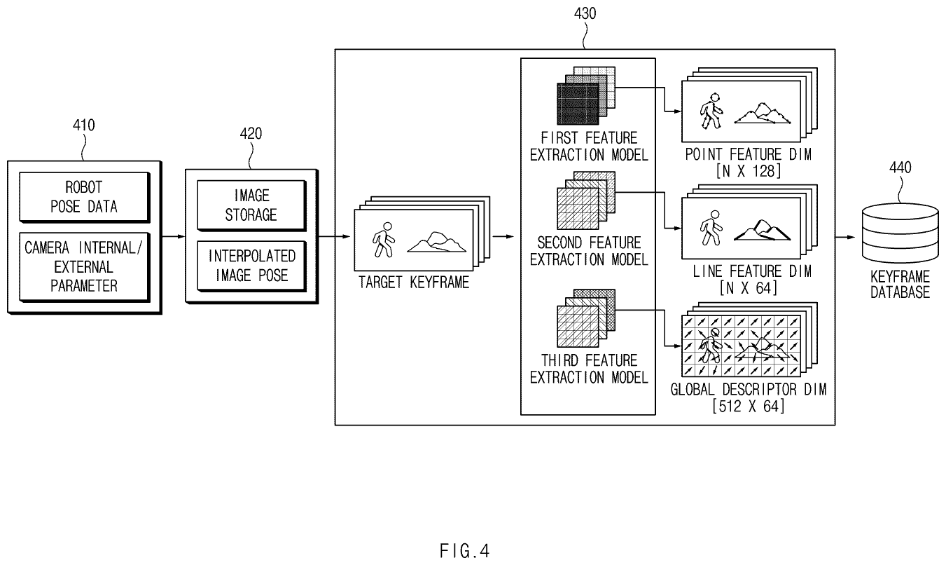

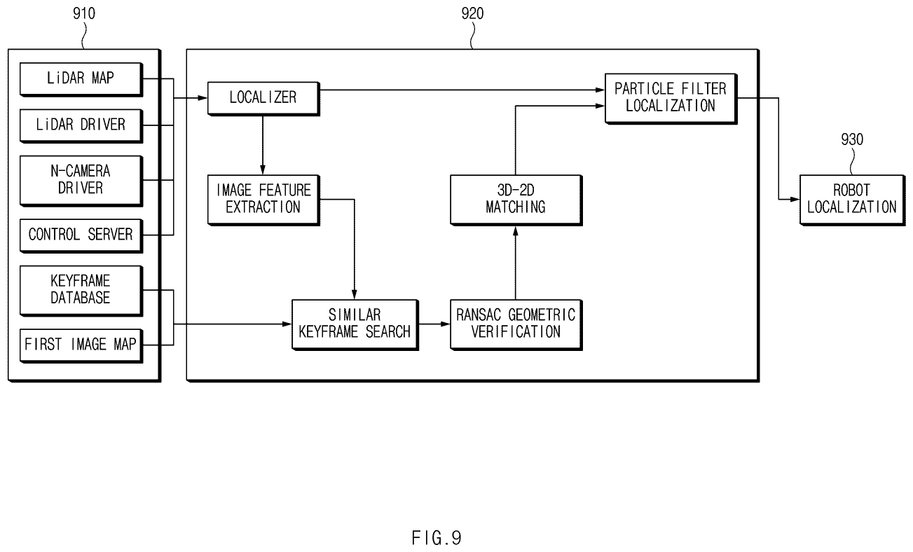

A processor (e.g., a processor 110 of FIG. 1) according to an embodiment may perform data acquisition 310, image map generation 320, and global localization 330. For example, the processor may obtain an image from a camera of a robot. The processor may obtain robot pose data from the robot. The processor may generate an image map, based on the obtained image and the obtained robot pose data. The processor may estimate a global position of the robot based on the generated image map. A detailed description of the data acquisition 310 will be given in FIG. 3. A detailed description of the image map generation 320 will be given below in FIGS. 4 to 8. A detailed description of the global localization 330 of the robot will be given below in FIG. 9.

The processor may obtain robot pose data including information about a position and a posture of the robot.

The processor may identify a first time point preceding a target time point when a target image is obtained and a second time point subsequent to the target time point when the target image is obtained. The processor may obtain a time weight about the target time point, based on first robot pose data of the robot, which corresponds to the first time point, and second robot pose data of the robot, which corresponds to the second time point. The time weight may be represented by Equation 1 below.

$$α = \frac{time [ t ] - time [ t - 1 ]}{time [ t + 1 ] - time [ t - 1 ]} \qquad [ Equation 1 ]$$

Herein, time[t] may refer to the value of the target time point of the time matrix, time[t−1] may refer to the value of the first time point of the time matrix, time[t+1] may refer to the value of the second time point of the time matrix, and a may refer to the time weight. Herein, the time matrix may indicate a matrix in which a state or a position of the robot are recorded over time based on Unix time.

The time weight may indicate a ratio between time points adjacent to the time point when the target image is obtained. The time weight may be a weight indicating a ratio of the target time point, which may be applied to an interpolation operation between two rotation matrices.

The processor may obtain robot pose data corresponding to the target time point, based on the first robot pose data, the second robot pose data, and the time weight. The robot pose data may be represented by Equation 2 below.

$${robotpose}_{t} = ( 1 - α ) {xrobotpose}_{t - 1} + α {xrobotpose}_{t + 1} \qquad [ Equation 2 ]$$

Herein, robotposeₜ may refer to the robot pose data at the target time point, robotposeₜ₋₁ may refer to the first robot pose data at the first time point, and robotposeₜ₊₁ may refer to the second robot pose data at the second target time point.

The processor may obtain directional data based on the pieces of robot pose data and the time weight. The directional data may be represented by Equation 3 below.

The processor may apply an external parameter including a position and a direction of an image acquisition device (e.g., a camera) to first position data to obtain image pose data. The processor may store the image pose data to which the external parameter is applied, the target image in a memory (e.g., a memory 120 of FIG. 1) and/or a keyframe database.

The image pose data may include a position and a direction of the camera. For example, the position of the camera may indicate a position of the camera mounted on the robot in the target space and the direction of the camera may indicate a direction the camera mounted on the robot faces in the target space.

The external parameter may define where the camera is located in the target space and which direction the camera is facing. For example, the external parameter may include a rotation matrix indicating how the camera should be rotated and a translation vector which is a vector indicating how far away it is from the origin of the robot.

An internal parameter may indicate a characteristic of the camera sensor itself and may define a transformation process when coordinates of a 3D world are transformed into image coordinates (e.g., pixel coordinates of the target image). For example, the internal parameter may include a focal length, which is a distance from the center of the lens of the camera to the image sensor, a principal point which refers to a point at which the optical axis of the lens meets the image sensor, and lens distortion coefficients about radial distortion and tangential distortion.

The image pose data may be represented by Equation 3 below.

$${imagepose}_{t} = {robotpose}_{t} x {T}_{camera \_ extrinsic} \qquad [ Equation 3 ]$$

Herein, robotposeₜ may indicate the robot pose data, T_{camera_extrinsic} may indicate the translation matrix indicating the external parameter of the camera, and imageposeₜ may indicate the image pose data.

If a data acquisition command is received from a control server, the processor may obtain a target image based on a current position and a camera parameter from the robot. In this process, the processor may synchronize and store the target image and the position of the robot, using state information (e.g., robot pose data, a camera parameter, or the like) of the robot.

The target image may be stored in a joint photographic experts group (JPEG) format. The image pose data corresponding to the target image may be stored in a text format. The processor may store time information (e.g., Unix time) of the target image together and may accurately match the target image with the image pose data.

FIG. 4 describes a method for generating a keyframe database in a global localization apparatus according to an embodiment of the present disclosure.

FIG. 4 describes a method for generating a keyframe database, based on data obtained from a robot, by a global localization apparatus (e.g., a global localization apparatus 100 of FIG. 1) according to an embodiment.

A processor (e.g., a processor 110 of FIG. 1) may generate the keyframe database, based on obtaining a target image.

In operation 410, the processor may receive data from the robot. For example, the robot may provide robot pose data and a camera parameter. A description of the robot pose data and the camera parameter (e.g., an external parameter and an internal parameter) may be the same as described above in FIG. 3. The data acquisition may be the same as described above in FIG. 3.

The processor may perform feature point extraction from a keyframe based on performing the data acquisition.

In operation 420, the processor may combine at least one of image pose data, the robot pose data, or the external parameter, or any combination thereof with the target image stored in a memory (e.g., a memory 120 of FIG. 1) to generate a target keyframe.

The target keyframe may include a pixel of the target image and a posture (i.e., image pose data) of a camera at a time point to obtain the target image. For example, the keyframe may indicate an image at a specific time point used to represent a position or an environment of the robot. Herein, the keyframe may include an image, image pose data, and robot pose data. In detail, the target keyframe may include at least one of the target image, the position (e.g., the image pose data) of the target image, the robot pose data (e.g., roll, pitch, and yaw of the robot), or the external parameter, or any combination thereof.

In operation 430, the processor may extract at least one feature from the target keyframe.

The processor may apply the target keyframe to a first feature extraction model for extracting a feature about a point of an object to obtain first data about a point feature of the object, which is included in the target keyframe. For example, the first feature extraction model may indicate a model for performing a scale-invariant feature transform (SIFT) algorithm or a speeded up robust features (SURF) algorithm. The first data may include a target in which the feature about the point of the object is represented with a 128-dimensional vector.

The processor may apply the target keyframe to a second feature extraction model for extracting a feature about a line of the object to obtain second data about a line feature of the object, which is included in the target keyframe. For example, the second feature extraction model may indicate a model for extracting a linear feature which is a structure, such as a straight line or a curve, in the image. The second data may include a target in which the feature about the line of the object is represented with a 64-dimensional vector.

The processor may apply the target keyframe to a third feature extraction model for extracting a global feature about object arrangement or color distribution to obtain third data about a global feature of the target keyframe. The third feature extraction model may indicate a model for performing deep-learning-based feature extraction and net-vector of locally aggregated descriptors (NetVLAD) about descriptor generation. The third data may include 512 individual local descriptors and a target in which each local descriptor is represented in 64 dimensions.

In operation 440, the processor may store the target keyframe, the first data, the second data, and the third data in a keyframe database.

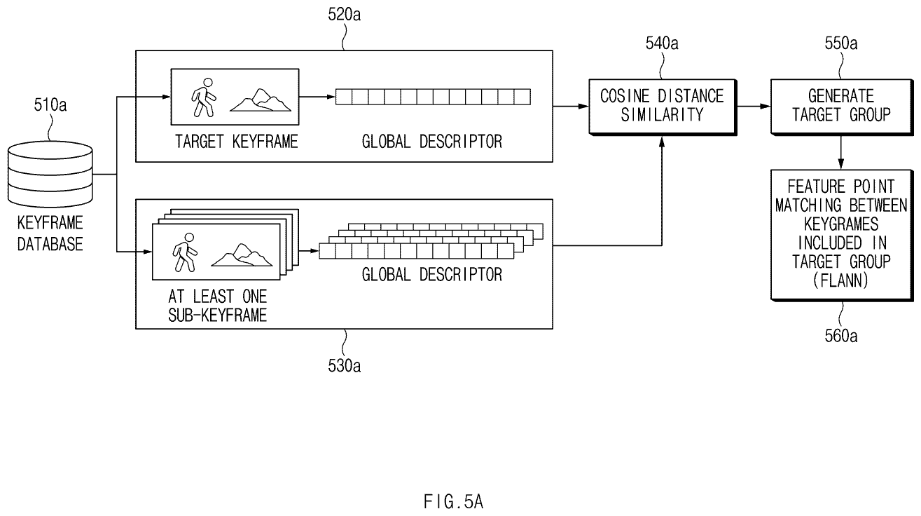

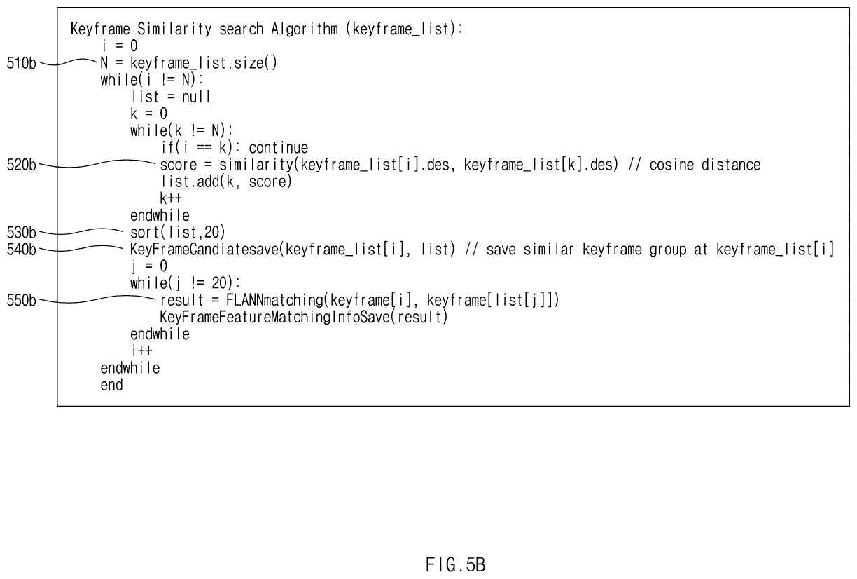

FIG. 5A is a drawing describing a method for measuring a similarity between keyframes in a global localization apparatus according to an embodiment of the present disclosure.

FIG. 5A is a drawing describing a method for generating a target group based on a keyframe database generated by a global localization apparatus (e.g., a global localization apparatus 100 of FIG. 1) according to an embodiment.

In operation 510a, a processor (e.g., a processor 110 of FIG. 1) according to an embodiment may identify at least one keyframe from the keyframe database. For example, the processor may measure a similarity between the keyframes. The processor may store keyframes with high similarities as one group. Hereinafter, a description will be given in detail of a method for generating one group in the processor.

The processor may perform grouping of keyframes based on resemblance. For example, the processor may calculate resemblance of each of keyframes based on image feature points extracted from the keyframe and may generate a group including 20 keyframes, which are most similar to each other. In this process, the processor may obtain resemblance between keyframes using a cosine similarity.

The processor may obtain at least one sub-keyframe from the keyframe database. The at least one sub-keyframe may include keyframes generated from an image obtained at a time point prior to a target time point.

In operations 520a and 530a, the processor may determine a cosine similarity between a global feature of a target keyframe and a global feature of each of the at least one sub-keyframe. For example, the global feature of the target keyframe may indicate third data of the target keyframe. In detail, the global feature may be a feature (e.g., a global descriptor) extracted from the keyframe, which may include the overall feature of the keyframe. The global feature may include a target in which the feature extracted from the keyframe is represented with a 4096-dimensional vector.

In operation 540a, the processor may determine the cosine similarity between the global feature of each of the at least one sub-keyframe and the global feature of the target keyframe. For example, if the number of the at least sub-keyframe is 3, the processor may determine a first cosine similarity, which is a similarity between the global feature of the target keyframe and a global feature of a first sub-keyframe, a second cosine similarity, which is a similarity between the global feature of the target keyframe and a global feature of a second sub-keyframe, and a third cosine similarity, which is a similarity between the global feature of the target keyframe and a global feature of a third sub-keyframe.

The cosine similarity may indicate a value obtained by calculating an angle between two vectors and measuring how similar the two vectors are. For example, the angle between the two vectors may indicate an angle between a first vector about the global feature of the target keyframe and a second vector about the global feature of one of the at least one sub-keyframe, in the space where the global feature is represented. In addition, the description of the angle between the two vectors is not limited to thereto. For example, the angle between the two vectors may indicate an angle between a first vector about a feature about a point of an object of the target keyframe or a feature about a line of the object and a second vector about a feature about a point of an object of one of the at least one sub-keyframe or a feature about a line of the object.

The processor may sort keyframes depending on the similarities based on the cosine similarity. Thereafter, the processor may select and set and/or generate the most similar keyframes (e.g., sub-keyframes with high similarities with the target keyframe) as one group. For example, the processor may select the most similar 20 keyframes to generate one group.

In operation 550a, the processor may determine sub-keyframes in which the cosine similarity of each of the at least one sub-keyframe corresponds to a predetermined score to generate a target group including the determined sub-keyframes and the target keyframe.

In operation 560a, the processor may perform two-dimensional (2D) feature point matching between the keyframes included in the target group based on a fast library for approximate nearest neighbors (FLANN) algorithm. For example, the processor may compare 2D feature points between the keyframes included in the target group to identify how features generated in the same object or structure correspond to each other.

The 2D feature point may indicate a specific point capable of being easily recognized from an image and being compared in several images. For example, the 2D feature point may be extracted from a corner, an edge, or texture included in the image. In detail, the processor may identify a first keyframe and a second keyframe among the keyframes included in the target group. The processor may perform 2D feature point matching, based on that a 2D feature point included in the first keyframe and a 2D feature point included in the second keyframe correspond to the same target in the target space. Illustratively, if the 2D feature point included in the first keyframe and the 2D feature point included in the second keyframe correspond to a part of an object (e.g., a wall, a corner, or the like) which is present in the target space, the processor may match the 2D feature point included in the first keyframe with the 2D feature point included in the second keyframe.

FIG. 5B illustrates a pseudocode indicating a source code for generating a target group.

FIG. 5B illustrates a pseudocode about an operation of performing grouping of keyframes based on resemblance in a processor and an operation of performing 2D feature point matching between keyframes included in a target group in the processor.

The processor may obtain a size of a keyframe list, as defined in a code 510b. Herein, the size of the keyframe list may indicate the number of keyframes included in a keyframe database.

The processor may obtain a similarity between keyframes, as defined in a code 520b. For example, the similarity may indicate a cosine similarity.

The processor may perform sorting, as defined in a code 530b. Thereafter, the processor may obtain sub-keyframes similar to a target keyframe, from a keyframe database, as defined in a code 540b. The processor may obtain the similar sub-keyframes to generate a target group.

The processor may perform 2D feature point matching between the keyframes included in the target group based on a FLANN algorithm as defined in a code 550b.

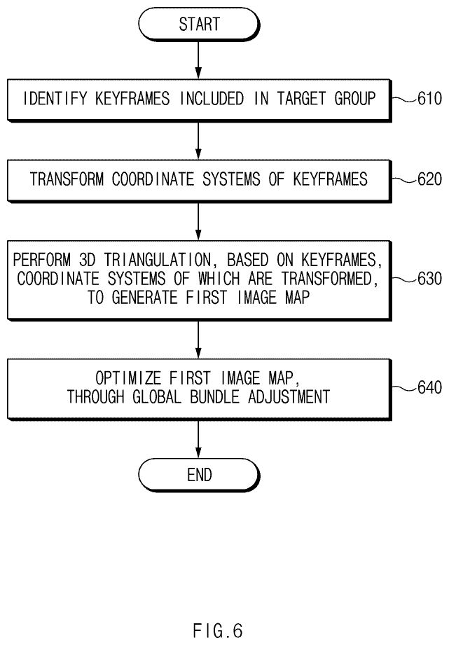

FIG. 6 is a drawing describing a method for generating a first image map in a global localization apparatus according to an embodiment of the present disclosure.

A processor (e.g., a processor 110 of FIG. 1) according to an embodiment may generate a first image map based on a keyframe database.

The first image map may indicate a 3D sparse image map. For example, the first image map may include a map on which objects presenting in a target space are represented as a feature point. Hereinafter, a detailed description of the method for generating the first image map based on the keyframe database in the processor will be given.

In operation 610, the processor may identify keyframes included in a target group from the keyframe database. Herein, the keyframes included in the target group may indicate keyframes which are similar to each other.

In operation 620, the processor may transform a robot coordinate system of each of the keyframes included in the target group into a coordinate system of an image acquisition device (e.g., a camera). Illustratively, the processor may transform the robot coordinate system of each of the keyframes included in the target group into a camera coordinate system (or an optical frame) to use collaborative mapping (COLMAP).

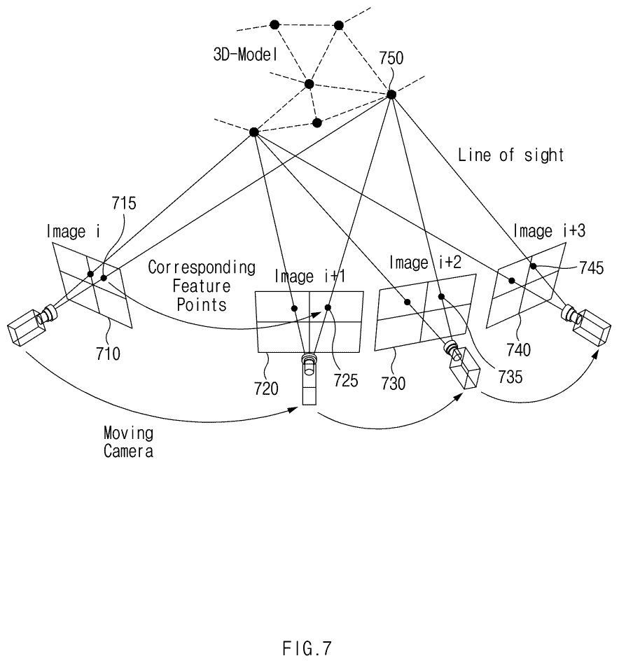

In operation 630, the processor may perform 3D triangulation, based on the result of 2D feature point matching between the keyframes included in the target group, an internal parameter about a lens characteristic of the image acquisition device, and image pose data of a target image. A detailed description of the 3D triangulation will be given below in FIG. 7.

Herein, the result of 2D feature point matching may indicate the result of matching 2D points between the keyframes included in the target group. Illustratively, if a first feature point of a first keyframe and a second feature point of a second keyframe correspond to the same target, the result of 2D feature point matching may be included in a form in which the first feature point and the second feature point are paired with each other.

The processor may obtain a point cloud based on a 3D feature point obtained by projecting a 2D feature point of each of the keyframes included in the target group onto a 3D space based on the 3D triangulation. For example, the 3D feature point may correspond to a 2D feature point of each of the keyframes included in the target group. In detail, the 3D feature point may be generated based on a 2D feature point corresponding to the same target between the keyframes.

The processor may generate a first image map based on the point cloud.

In operation 640, the processor may optimize the first image map through global bundle adjustment of the 3D feature point, the 2D feature point of each of the keyframes included in the target group, the internal parameter, and the robot pose data.

The global bundle adjustment may indicate an operation of optimizing the point cloud extracted from at least one image or at least one keyframe to obtain an accurate point cloud.

The processor may determine a cost function indicating the 2D feature point (e.g., pixel coordinates which are an image feature point) and the 3D feature point (e.g., 3D coordinates of a real object). For example, the processor may determine a cost function indicating a difference between the 2D feature point and a position on which the 2D feature point is projected, based on the robot pose data and the internal parameter.

The processor may minimize of the cost function, based on a least-squares optimization algorithm. The processor may complete the optimization of the first image map, based on that the cost function is minimized.

FIG. 7 is a drawing describing 3D triangulation in a global localization apparatus according to an embodiment of the present disclosure.

A processor (e.g., a processor 110 of FIG. 1) according to an embodiment may perform 3D triangulation, based on the result of 2D feature point matching between keyframes included in a target group, an internal parameter of a camera, and image pose data of a target image. Hereinafter, the keyframe may be described as including an image.

Referring to FIG. 7, a plurality of images obtained from a moving camera are illustrated. The plurality of images may include a first image 710, a second image 720, a third image 730, and a fourth image 740.

The first image 710 may indicate an image in which the camera captures a 3D object in a line of sight. The second image 720 may indicate an image in which the camera captures the 3D object in a second line of sight. The third image 730 may indicate an image in which the camera captures the 3D object in a third line of sight. The fourth image 740 may indicate an image in which the camera captures the 3D object in a fourth line of sight.

A 3D model shown in FIG. 7 may correspond to a target in which a specific object presenting in a target space is represented on a robot coordinate system. The specific object may be included in the first to fourth images 710 to 740.

The processor may match feature points included in each of the first to fourth images 710 to 740. For example, a first feature point 715 of the first image 710 may be matched with a second feature point 725 of the second image 720, a third feature point 735 of the third image 730, and a fourth feature point 745 of the fourth image 740.

The processor may determine a point at which a line connecting the position of the camera and the first feature point 715, a line connecting the position of the camera and the second feature point 725, a line connecting the position of the camera and the third feature point 735, and a line connecting the position of the camera and the fourth feature point 745 cross one another as a 3D feature point 750. The 3D feature point 750 may be a point corresponding to the first feature point 715, the second feature point 725, the third feature point 735, and the fourth feature point 745.

The 2D feature point matching described in the specification may be illustratively described as an operation in which the first feature point 715 of the first image 710 is matched with the second feature point 725 of the second image 720, the third feature point 735 of the third image 730, and the fourth feature point 745 of the fourth image 740.

The 3D triangulation described in the specification may be illustratively described as an operation of obtaining a 3D feature point based on the line connecting the position of the camera and the first feature point 715, the line connecting the position of the camera and the second feature point 725, the line connecting the position of the camera and the third feature point 735, and the line connecting the position of the camera and the fourth feature point 745.

The processor may obtain a point cloud based on obtaining the at least one 3D feature point. The processor may generate a first image map, which is a 3D sparse image map, based on the point cloud.

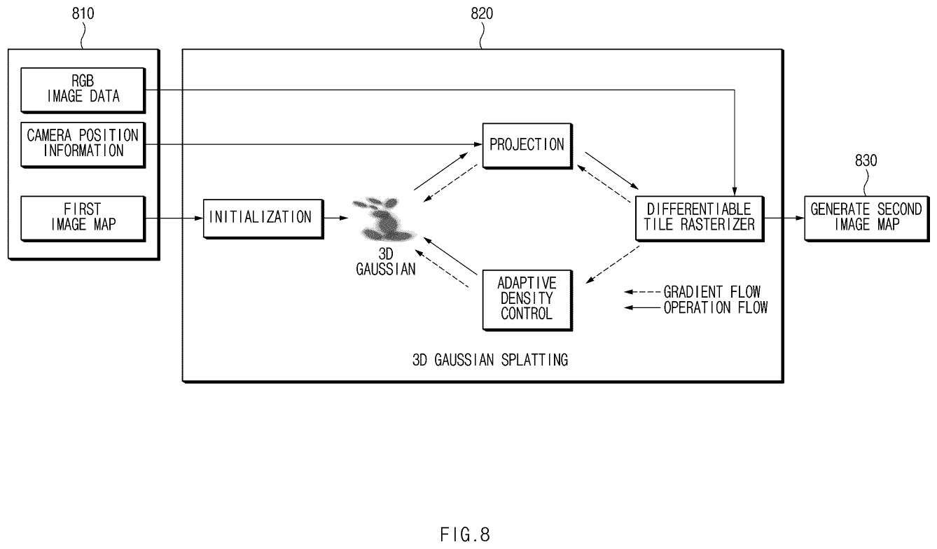

FIG. 8 is a drawing describing a method for generating a second image map in a global localization apparatus according to an embodiment of the present disclosure.

FIG. 8 is a drawing describing a method for generating a second image map based on a first image map generated by a global localization apparatus (e.g., a global localization apparatus 100 of FIG. 1) according to an embodiment.

A processor (e.g., a processor 110 of FIG. 1) may perform 3D Gaussian splatting of the first image map to obtain the second image map which is a 3D dense image map.

In operation 810, the processor may identify image data, camera position information, and the first image map. For example, in operation 820, the processor may perform 3D Gaussian splatting for 3D feature points extracted from the first image map, an external parameter and an internal parameter extracted from the camera position information, and a target image which is image data to obtain a projected image. However, the method for obtaining the projected image is not limited thereto. For example, the processor may perform 3D Gaussian splatting for a 2D image captured in a real environment, rather than the target image. The 3D feature points may be obtained from the first image map.

The processor may initialize point data included in the first image map to 3D Gaussian distribution (i.e., 3D Gaussian Initialization). In this step, the processor may transform and process the point data into 3D Gaussian.

The processor may project the 3D Gaussian onto an image plane to generate a 2D Gaussian splat. The 2D Gaussian splat may indicate a projected image.

The processor may update the projected image, based on a loss between the projected image and the target image. For example, the processor may compare the projected 2D Gaussian pixel (i.e., a pixel of the projected image) with a real image pixel (i.e., a pixel of the target image) to calculate a loss and may perform an update in a Gaussian form based on a gradient according to the loss. The processor may repeatedly perform the update operation, based on a predetermined difference and/or loss or a predetermined repetition number. Herein, the loss may be a value indicating how much the projected image generated from a 3D point cloud (or 3D feature points) matches a real image.

In operation 830, the processor may obtain a second image map which is a 3D dense image map based on that the projected image is updated. The second image map may be provided from a control server to a global localization apparatus.

FIG. 9 is a drawing illustrating a method for estimating a global position of a robot in a global localization apparatus according to an embodiment of the present disclosure.

FIG. 9 is a drawing describing a method for estimating a global position of a robot in a global localization apparatus (e.g., a global localization apparatus 100 of FIG. 1) according to an embodiment.

A processor (e.g., a processor 110 of FIG. 1) according to an embodiment may receive an event about global localization of a robot from a control server.

If an event is received, the processor may control a localizer. For example, by controlling the localizer (e.g., a localizer manager), in operation 910, the processor may obtain data from a LiDAR map, a LiDAR driver, a camera driver, and a control server.

The LiDAR map may be a map of a LiDAR sensor of a robot to construct a 3D map of a surrounding environment. The LiDAR driver may be a driver for controlling the LiDAR sensor and collecting data. The camera driver may be a driver for controlling several cameras of the robot. The control server may be a server for controlling an operation of the robot.

In operation 920, the processor may perform operations for estimating a global position of the robot. Hereinafter, a description before the operation of estimating the global position of the robot in the processor will be given.

The processor may estimate a position based on a current image received from a camera to check the global position of the robot. For example, the processor may extract a feature point from the image obtained from the camera (e.g., image feature extraction). The processor may manage the extracted feature point of the image and may compare the feature point with data stored in a keyframe database to identify a similar image (e.g., a keyframe).

The processor may obtain a query image from a camera. For example, the query image may be an image streamed in real time from the camera.

The processor may determine a cosine similarity between a query frame about the query image and each of at least one sub-keyframe included in the keyframe database (e.g., similar keyframe search) to generate a query group including sub-keyframes similar to the query frame. Herein, the operation of generating the query group may include an operation of determining and selecting sub-keyframes with high similarities based on a cosine similarity between global features of the query frame and each of the at least one sub-keyframe.

The processor may perform 3D triangulation of keyframes included in the query group to obtain a 3D feature point. In detail, the processor may select the most geometrically similar keyframe using a RANSAC algorithm (e.g., RANSAC geometric verification) among the keyframes included in the query group.

The processor may perform matching of a 2D feature point and a 3D feature point (e.g., 3D-2D matching) of the query frame to obtain at least one candidate position about an estimated position of the robot. Herein, the processor may determine a candidate position of the robot which is located at a time point when the query image is obtained using a perspective-n-point algorithm and local bundle adjustment. For example, the candidate position of the robot may be described by Equation 4 below.

$${sp}_{c} = K [ R \vert T ] {p}_{w} \qquad [ Equation 4 ]$$

Herein, s may refer to the scale factor used to adjust the depth, pc may refer to the 2D feature point of the query frame on the camera coordinate system, K may refer to the internal parameter matrix of the camera, and pw may refer to the 3D feature point on the world coordinate system.

The processor may obtain a position and a direction of the camera based on the rotation matrix (e.g., R) and the translation vector (e.g., T) according to Equation 4 above. The processor may determine a candidate position of the robot based on the position and the direction of the camera.

The processor may identify a target candidate position about a score corresponding to a predetermined score among scores of each of the at least one candidate position and may determine the target candidate position as a global position. The operation of determining the score of each of the at least one candidate position may be performed by the processor, based on particle filter localization (e.g., Particle Filter Localization).

In detail, the processor may determine a score of each of the at least one candidate position based on the at least one candidate position and a LiDAR map obtained from LiDAR. For example, the processor may generate a particle and may estimate a position of the robot, based on the 3D-2D matching result (i.e., the candidate position).

The processor may generate a particle, based on particle sampling, from the at least one candidate position. The processor may compare the particle with data of a current LiDAR map to calculate a score. The processor may determine a score of each of particles, using the LiDAR map, a generalized iterative closest point (GICP) algorithm, and a likelihood field.

In operation 930, the processor may determine a particle corresponding to the highest score among the scores of each of the particles as a global position of the robot.

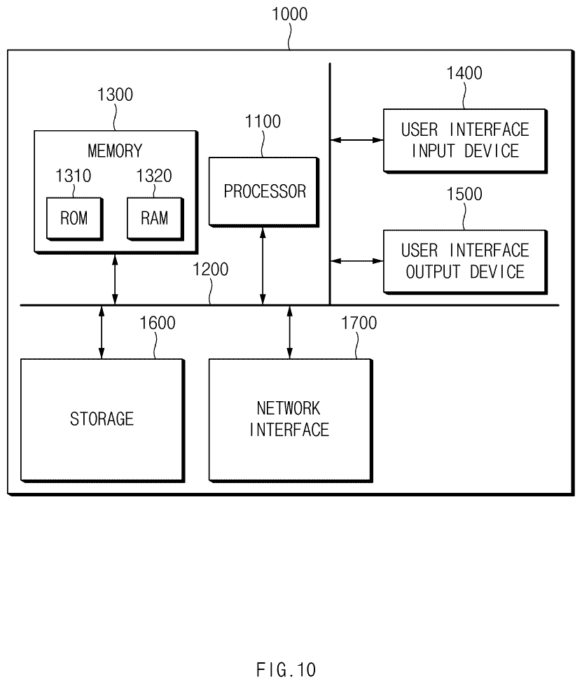

FIG. 10 is a drawing illustrating a computing system associated with a global localization apparatus or a global localization method according to an embodiment of the present disclosure.

Referring to FIG. 10, a computing system 1000 of the global localization apparatus or the global localization method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs), magneto-optical media such as floptical disks, and hardware devices that are specially configured to store and perform program instructions such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it may be obviously to one skilled in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description will be given of the effects of the global localization apparatus and the method thereof according to an embodiment of the present disclosure.

According to at least one of embodiments of the present disclosure, the global localization apparatus may generate an image map about a target space based on robot pose data and a target image, may obtain a global position of a robot based on the image map and a LiDAR map obtained from LiDAR to combine pieces of camera and LiDAR data and precisely estimate and/or determine a position of the robot located in a complicated indoor environment or an environment with an unstable GPS signal.

In addition, various effects ascertained directly or indirectly through the present disclosure may be provided.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A global localization apparatus comprising:
a memory storing computer-executable instructions; and
at least one processor,
wherein the instructions, when executed by the at least one processor, enable the apparatus to:
obtain robot pose data of a position and a direction of a robot;
obtain a target image corresponding to a target space where the robot is located from an image acquisition device of the robot;
generate an image map of the target space based on the robot pose data and the target image; and
obtain a global position of the robot based on the image map and a light detection and ranging (LiDAR) map obtained from a LiDAR of the robot.

2. The global localization apparatus of claim 1, wherein the instructions enable the apparatus to:
identify a first time point preceding a target time point when the target image is obtained and a second time point subsequent to the target time point when the target image is obtained;
obtain a time weight of the target time point based on first robot pose data of the robot, the first robot pose data corresponding to the first time point, and second robot pose data of the robot, the second robot pose data corresponding to the second time point; and
obtain the robot pose data corresponding to the target time point based on the first robot pose data, the second robot pose data, and the time weight.

3. The global localization apparatus of claim 2, wherein the instructions enable the apparatus to:
apply an external parameter including a position and a direction of the image acquisition device in the target space to the robot pose data to obtain image pose data of a position and a direction of the target image; and
store the image pose data and the target image in the memory.

4. The global localization apparatus of claim 3, wherein the instructions enable the apparatus to:
combine at least one of the image pose data, the robot pose data, the external parameter, or any combination thereof with the target image stored in the memory to generate a target keyframe;
apply the target keyframe to a first feature extraction model for extracting a feature of a point of an object to obtain first data of a point feature of the object, the point feature being included in the target keyframe;
apply the target keyframe to a second feature extraction model for extracting a feature of a line of the object to obtain second data of a line feature of the object, the line feature being included in the target keyframe;
apply the target keyframe to a third feature extraction model for extracting a global feature of an object arrangement or color distribution to obtain third data of a global feature of the target keyframe; and
store the target keyframe, the first data, the second data, and the third data in a keyframe database.

5. The global localization apparatus of claim 4, wherein the instructions enable the apparatus to:
obtain at least one sub-keyframe from the keyframe database;
determine a cosine similarity between the global feature of the target keyframe and a global feature of each of the at least one sub-keyframe;
determine sub-keyframes in which the cosine similarity of each of the at least one sub-keyframe corresponds to a predetermine a score to generate a target group including the determined sub-keyframes and the target keyframe; and
perform two-dimensional (2D) feature point matching between the keyframes included in the target group, based on a fast library for approximate nearest neighbors (FLANN) algorithm.

6. The global localization apparatus of claim 5, wherein the instructions enable the apparatus to:
identify a first keyframe and a second keyframe among the keyframes included in the target group; and
match a 2D feature point included in the first keyframe with a 2D feature point included in the second keyframe based on that the 2D feature point included in the first keyframe and the 2D feature point included in the second keyframe correspond to the same target in the target space.

7. The global localization apparatus of claim 5, wherein the instructions enable the apparatus to:
transform a robot coordinate system of each of the keyframes included in the target group into a coordinate system of the image acquisition device;
perform a three-dimensional (3D) triangulation based on a result of the 2D feature point matching between the keyframes included in the target group, an internal parameter of a lens characteristic of the image acquisition device, and the image pose data of the target image;
obtain a point cloud, based on a 3D feature point obtained by projecting a 2D feature point of each of the keyframes included in the target group onto a 3D space, through the 3D triangulation; and
generate a first image map, being a 3D sparse image map, based on the point cloud.

8. The global localization apparatus of claim 7, wherein the instructions enable the apparatus to optimize the first image map though global bundle adjustment of the 3D feature point, the 2D feature point of each of the keyframes included in the target group, the internal parameter, and the robot pose data.

9. The global localization apparatus of claim 7, wherein the instructions enable the apparatus to:
perform 3D Gaussian splatting for the 3D feature point, the external parameter, the internal parameter, and the target image to obtain a projected image;
update the projected image based on a loss between the projected image and the target image;
obtain a second image map being a 3D dense image map based on that the projected image is updated; and
transmit the second image map to a control server.

10. The global localization apparatus of claim 4, wherein the at instructions enable the apparatus to:
obtain a query image from the image acquisition device based on receiving an event of a global localization of the robot;
determine a cosine similarity between a query frame of the query image and each of at least one sub-keyframe included in the keyframe database to generate a query group including sub-keyframes similar to the query frame;
perform 3D triangulation of the keyframes included in the query group to obtain a 3D feature point; and
match a 2D feature point of the query frame with the 3D feature point to obtain at least one candidate position of an estimated position of the robot.

11. The global localization apparatus of claim 10, wherein the instructions enable the apparatus to:
determine scores of each of the at least one candidate position based on the at least one candidate position and the LiDAR map obtained from the LiDAR; and
identify a target candidate position about a score corresponding to a predetermined score among the scores of each of the at least one candidate position; and
determine the target candidate position as the global position.

12. A method comprising:
obtaining, by a processor of global localization apparatus, robot pose data of a position and a direction of a robot;
obtaining, by the processor, a target image corresponding to a target space where the robot is located from an image acquisition device of the robot;
generating, by the processor, an image map of the target space based on the robot pose data and the target image; and
obtaining, by the processor a global position of the robot based on the image map and a light detection and ranging (LiDAR) map obtained from a LiDAR of the robot.

13. The method of claim 12, wherein obtaining the target image comprises:
identifying a first time point preceding a target time point when the target image is obtained and a second time point subsequent to the target time point when the target image is obtained;
obtaining a time weight of the target time point based on first robot pose data of the robot, the first robot pose data corresponding to the first time point, and second robot pose data of the robot, the second robot pose data corresponding to the second time point; and
obtaining the robot pose data corresponding to the target time point based on the first robot pose data, the second robot pose data, and the time weight.

14. The method of claim 13, wherein obtaining the robot pose data comprises:
applying an external parameter including a position and a direction of the image acquisition device in the target space to the robot pose data to obtain image pose data of a position and a direction of the target image; and
storing the image pose data and the target image in a memory of the global localization apparatus.

15. The method of claim 14, wherein storing the image pose data and the target image in the memory comprises:
combining at least one of the image pose data, the robot pose data, the external parameter, or any combination thereof with the target image stored in the memory to generate a target keyframe;
applying the target keyframe to a first feature extraction model for extracting a feature of a point of an object to obtain first data of a point feature of the object, the point feature being included in the target keyframe;
applying the target keyframe to a second feature extraction model for extracting a feature of a line of the object to obtain second data of a line feature of the object, the line feature being included in the target keyframe;
applying the target keyframe to a third feature extraction model for extracting a global feature of an object arrangement or color distribution to obtain third data of a global feature of the target keyframe; and
storing the target keyframe, the first data, the second data, and the third data in a keyframe database.

16. The method of claim 15, wherein storing the image pose data and the target image in the memory comprise:
obtaining at least one sub-keyframe from the keyframe database;
determining a cosine similarity between the global feature of the target keyframe and a global feature of each of the at least one sub-keyframe;
determining sub-keyframes in which the cosine similarity of each of the at least one sub-keyframe corresponds to a predetermine score to generate a target group including the determined sub-keyframes and the target keyframe; and
performing a 2D feature point matching between the keyframes included in the target group, based on a fast library for approximate nearest neighbors (FLANN) algorithm.

17. The method of claim 16, wherein performing the 2D feature point matching between the keyframes included in the target group comprises:
identifying a first keyframe and a second keyframe among the keyframes included in the target group; and
matching a 2D feature point included in the first keyframe with a 2D feature point included in the second keyframe based on that the 2D feature point included in the first keyframe and the 2D feature point included in the second keyframe correspond to the same target in the target space.

18. The method of claim 16, wherein generating the image map comprises:
transforming a robot coordinate system of each of the keyframes included in the target group into a coordinate system of the image acquisition device;
performing 3D triangulation based on a result of the 2D feature point matching between the keyframes included in the target group, an internal parameter of a lens characteristic of the image acquisition device, and the image pose data of the target image;
obtaining a point cloud, based on a 3D feature point obtained by projecting a 2D feature point of each of the keyframes included in the target group onto a 3D space, through the 3D triangulation; and
generating a first image map being a 3D sparse image map based on the point cloud.

19. The method of claim 18, wherein generating the image map comprises:
performing 3D Gaussian splatting for the 3D feature point, the external parameter, the internal parameter, and the target image to obtain a projected image;
updating the projected image, based on a loss between the projected image and the target image;
obtaining a second image map being a 3D dense image map, based on that the projected image is updated; and
transmitting the second image map to a control server.

20. The method of claim 15, wherein the obtaining of the global position of the robot comprises:
obtaining a query image from the image acquisition device based on receiving an event of a global localization of the robot;
determining a cosine similarity between a query frame of the query image and each of at least one sub-keyframe included in the keyframe database to generate a query group including sub-keyframes similar to the query frame;
performing 3D triangulation of the keyframes included in the query group to obtain a 3D feature point;
matching a 2D feature point of the query frame with the 3D feature point to obtain at least one candidate position of an estimated position of the robot;
determining scores of each of the at least one candidate position based on the at least one candidate position and the LiDAR map obtained from the LiDAR;
identifying a target candidate position about a score corresponding to a predetermined score among the scores of each of the at least one candidate position; and
determining the target candidate position as the global position.
